(19) United States
(12) Patent Application Publication
(10) Pub. No.: US 2016/0028151 A1
(43) Pub. Date: Jan. 28, 2016

(54) HOUSING, ELECTRONIC DEVICE USING SAME, AND METHOD FOR MAKING SAME

(71) Applicant: Chiun Mai Communication Systems, Inc., New Taipei (TW)

(72) Inventors: MONG-HAU TSAI, New Taipei (TW); CHUN-YU CHEN, New Taipei (TW); CHIA-HUNG SU, New Taipei (TW); CHIH-CHEN CHANG, New Taipei (TW); CHIEN-HUNG LIN, New Taipei (TW); AN-JUI CHANG, New Taipei (TW)

(21) Appl. No.: 14/594,694

(22) Filed: Jan. 12, 2015

(30) Foreign Application Priority Data
Jul. 25, 2014 (CN) 201410361610.4

(51) Int. Cl. H01Q 1/24; B21D 5/00

(52) U.S. Cl. CPC H01Q 1/243; B21D 5/00

(57) ABSTRACT

A housing, includes a base and at least one non-conductive element, the base has at least one metal sheet and at least one main body, the metal sheet and the at least one main body both have a plurality of nano-pores, the non-conductive element is located at the spaces between the at least one main body and the metal sheet adjacent to the main body, and filled into the nano-pores to bond the at least one metal sheet and the at least one main body together.

### FIELD

The subject matter herein generally relates to a housing, an electronic device using the housing, and a method for making the housing.

### BACKGROUND

Metal housings are widely used for electronic devices such as mobile phones or personal digital assistants (PDAs). Antennas are also important components in electronic devices. But the signal of the antenna located in the metal housing is often shielded by the metal housing.

### BRIEF DESCRIPTION OF THE FIGURES

Implementations of the present technology will now be described, by way of example only, with reference to the attached figures.

FIG. 1 is an isometric view of an electronic device, according to an exemplary embodiment.

FIG. 2 is an isometric view of a housing of the electronic device shown in FIG. 1.

FIG. 3 is similar to FIG. 2, but shown from another angle.

FIG. 4 is an exploded, isometric view of the housing shown in FIG. 2, according to the first exemplary embodiment.

FIG. 5 is an exploded, isometric view of the housing shown in FIG. 2, according to the second exemplary embodiment.

FIG. 6 is an exploded, isometric view of the housing shown in FIG. 2, according to the third exemplary embodiment.

FIG. 7 is an exploded, isometric view of the housing shown in FIG. 2, according to the fourth exemplary embodiment.

FIG. 8 is a cross-sectional view of the housing along line VIII-VIII of FIG. 2.

FIG. 9 is a cross-sectional view of the housing along line IX- IX of FIG. 2.

FIG. 10 is a flow chart of a method for making a housing in accordance with an exemplary embodiment.

FIG. 11 is a flow chart of a method for making a housing in accordance with another exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be present. The term “comprising,” when utilized, means “including, but not necessarily limited to”; it specifically indicates open-ended inclusion or membership in the so-described combination, group, series and the like.

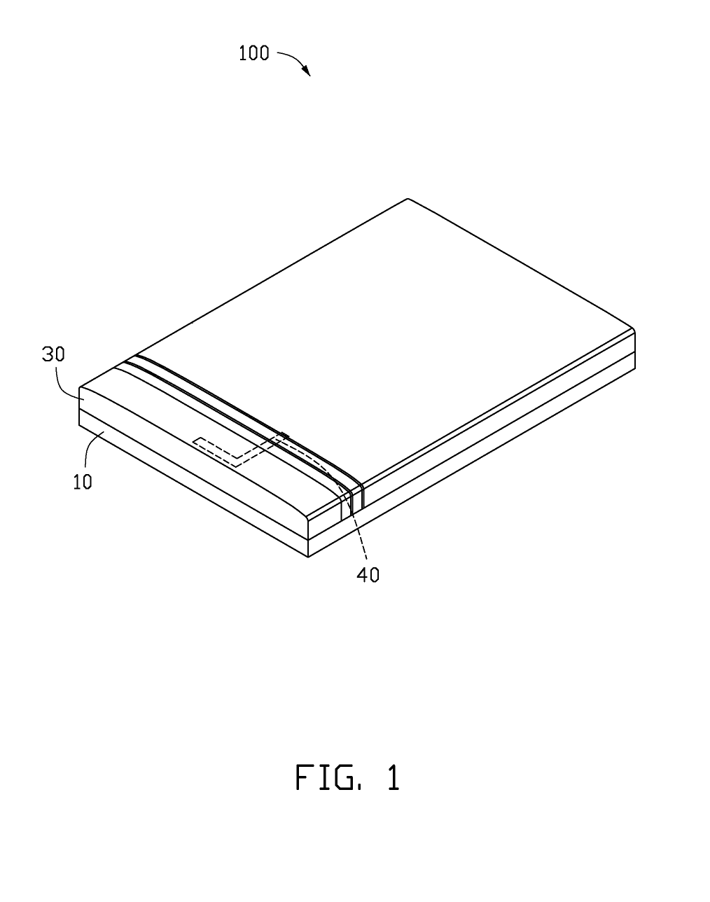

FIG. 1 illustrates an electronic device 100 according to an exemplary embodiment. The electronic device 100 can be, but not limited to, a mobile phone, a personal digital assistant or a tablet computer. The electronic device 100 includes a body 10, a housing 30 assembled to the body 10, and an antenna 40 located inside the housing 30.

The body 10 can have a printed circuit board (PCB) (not shown) and a battery (not shown) electronically connected with the PCB. The battery can charge the electronic device 100.

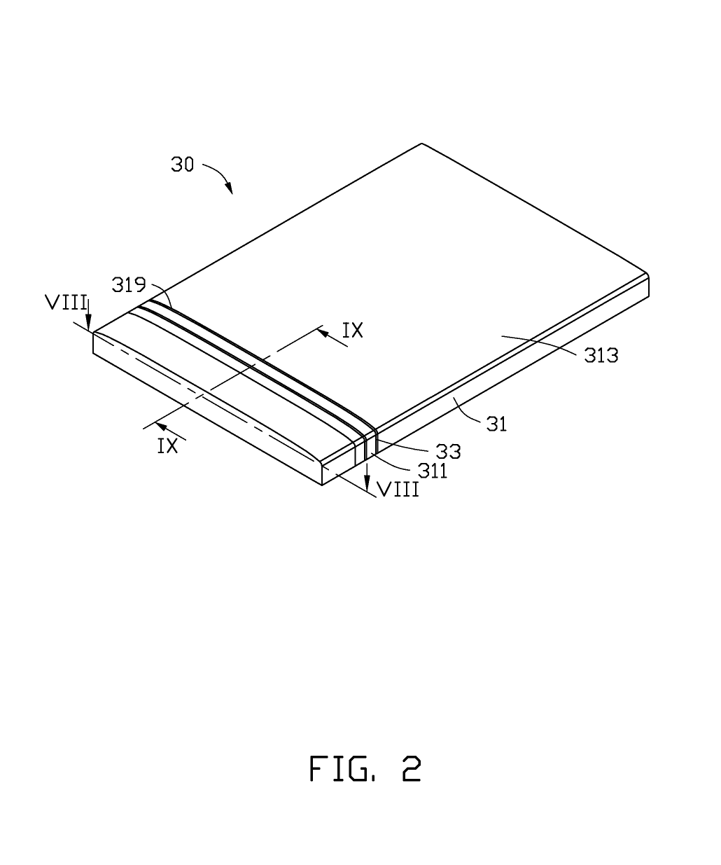

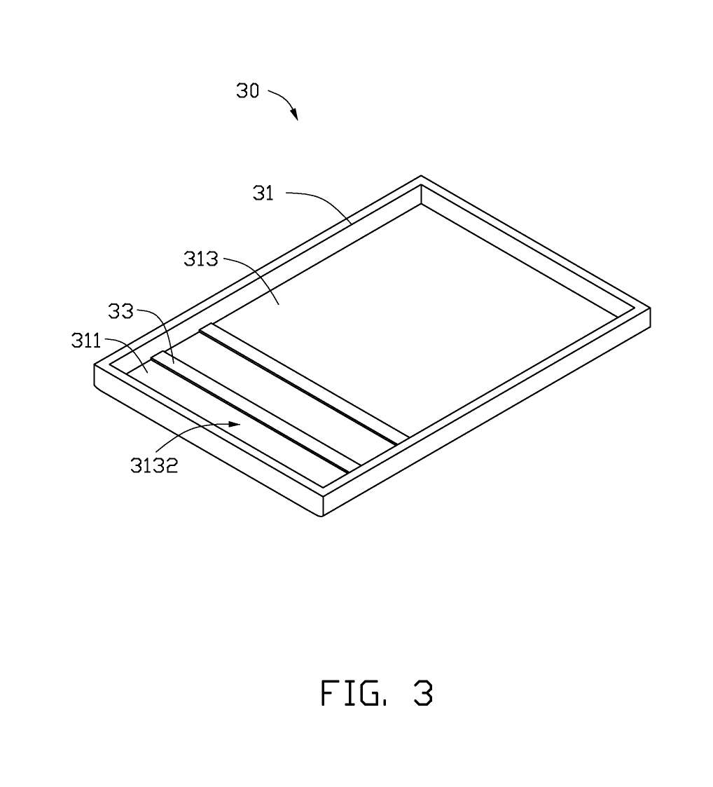

FIGS. 2-3 illustrate that in one exemplary embodiment, the housing 30 can be a back cover of the electronic device 100. The housing 30 can include a base 31 and at least one non-conductive element 33 received in the base 31.

The base 31 can be made of metal which can be selected from a group consisting of aluminium, aluminium alloy, magnesium, magnesium alloy, titanium, titanium alloy, copper and copper alloy. The base 31 can include at least one metal sheet 311 and at least one main body 313.

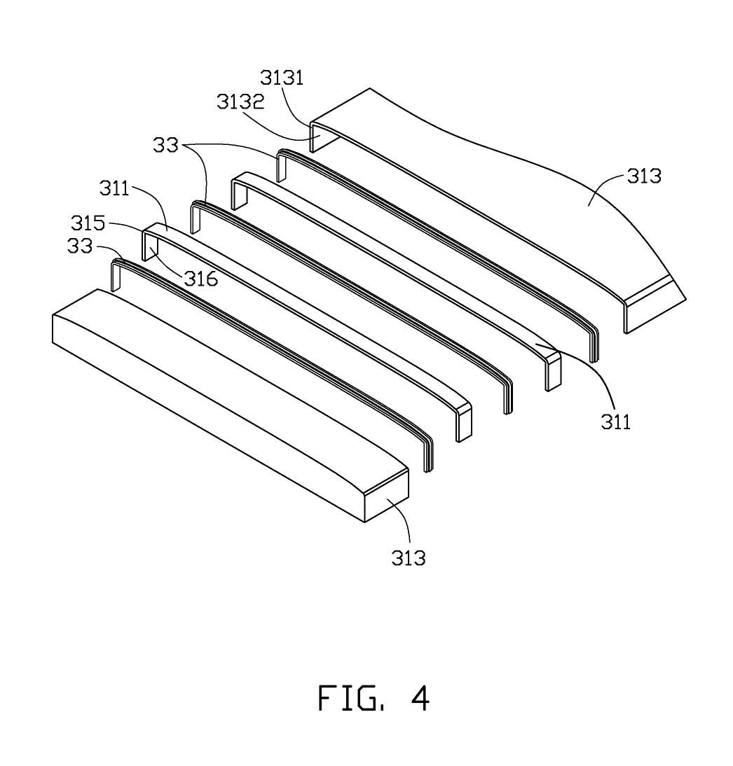

FIGS. 3-4 illustrate that each metal sheet 311 can have two lateral surfaces 315 parallel to each other, and an internal surface 316 connected with the lateral surfaces 315. Each main body 313 can also have a lateral surface 3131 facing the lateral surfaces 315 of the metal sheets 311, and an internal surface 3132 adjacent to the lateral surface 3131 of the main body 313.

The at least one main body 313 and the at least one metal sheet 311 can be arranged to be aligned with each other. Sections of a portion of the base 31 can have at least one gap 319, the base 31 can be spaced by the at least one gap 319, forming at least one metal sheet 311 and the at least one main body 313. Each non-conductive element 33 can be positioned in one gap 319, so that the at least one main body 313 and the at least one metal sheet 311 can be fixed together by the at least one non-conductive element 33. Each gap 319 can have a width of about 0.1 mm to about 0.3 mm along a direction from an adjacent non-conductive element 33 located at one side of metal sheet 311 to another adjacent non-conductive element 33 located at an opposite side of the metal sheet 311. The antenna 40 can be located inside the housing 30 and correspond to the gap 319.

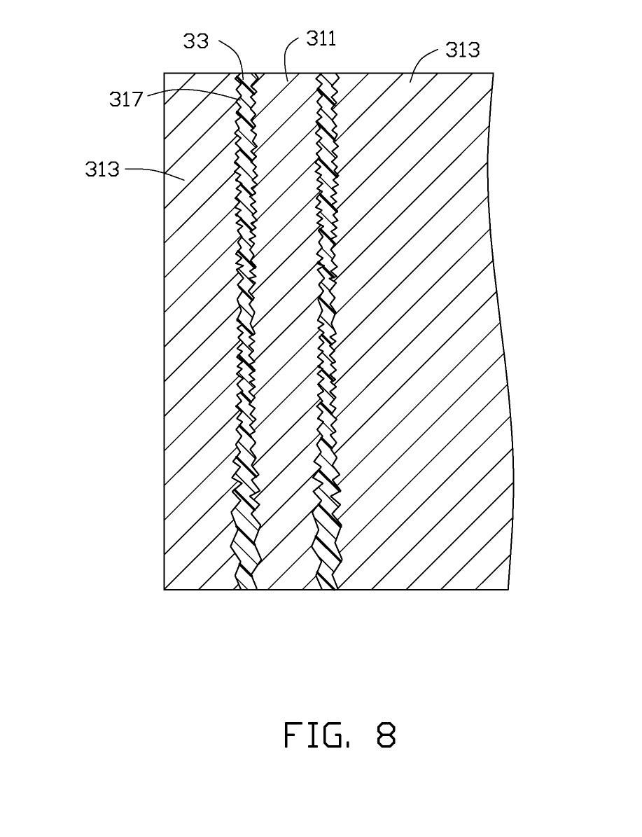

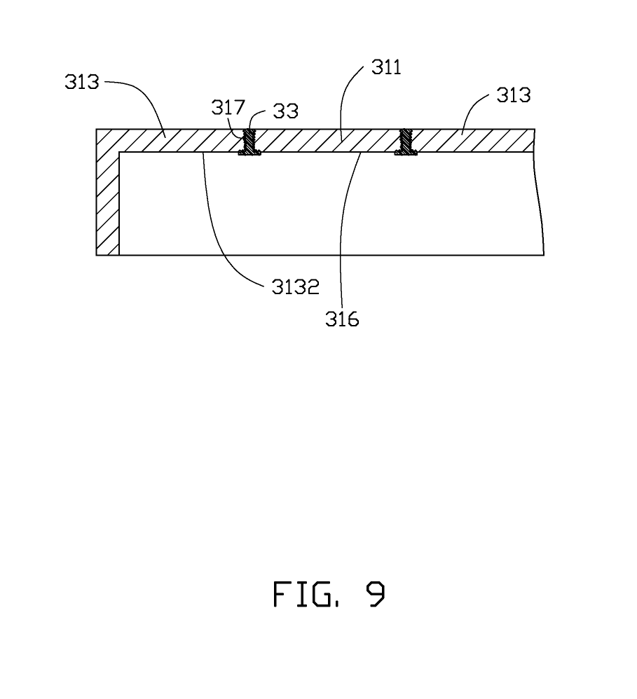

FIGS. 8-9 illustrate that the lateral surfaces 315, 3131 and the internal surface 316, 3132 can all have a plurality of nano-pores 317 with a diameter of about 10 nm to about 300 nm. In at least one exemplary embodiment, the nano-pores 317 can be formed by an anodic oxidation process, a dipping process, a chemical etching process or an electrochemical etching process. The surface roughness of the lateral surfaces 315, 3131 and the internal surface 316, 3132 can be about 0.1 μm to about 1 μm.

In at least one exemplary embodiment, the nano-pores 317 are directly formed on the lateral surfaces 315, 3131 and the internal surface 316, 3132, and the lateral surfaces 315, 3131 and the internal surface 316, 3132 may not receive an oxide film.

In at least one exemplary embodiment, the lateral surfaces 315, 3131 and the internal surfaces 316, 3132 can have an oxide film, and the oxide film has a plurality of nano-pores 317 having a diameter of about 10 nm to about 300 nm, the surface roughness of the lateral surfaces 315, 3131 and the internal surface 316, 3135 having the oxide film can be about 0.1 μm to about 1 μm.

FIGS. 4 and 9 illustrate that in at least one exemplary embodiment, the number of the non-conductive elements 33 can be three, the non-conductive elements 33 can be connected with the lateral surfaces 315, 3131 and the internal surfaces 316, 3132, and filled into the nano-pores 317 of the lateral surfaces 315, 3131 and the internal surface 316, 3132. The non-conductive elements 33 can be substantially “T” shaped.

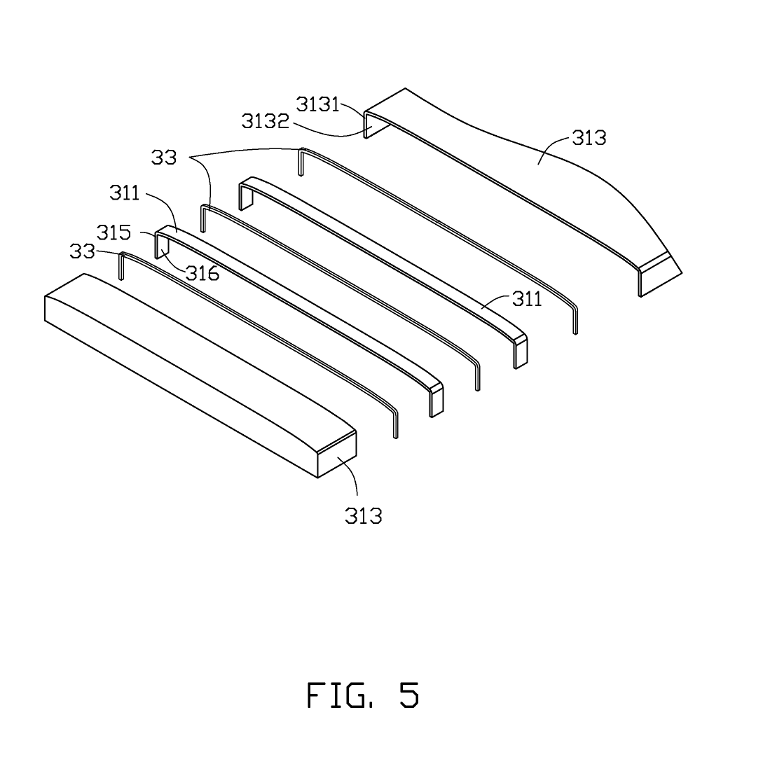

FIG. 5 illustrates that in at least one exemplary embodiment, the number of the non-conductive elements 33 can be three, and the non-conductive elements 33 can be connected with the lateral surfaces 315, 3131 and filled into the nano-pores 317 of the lateral surfaces 315, 3131. The non-conductive elements 33 can be substantially sheet-shaped.

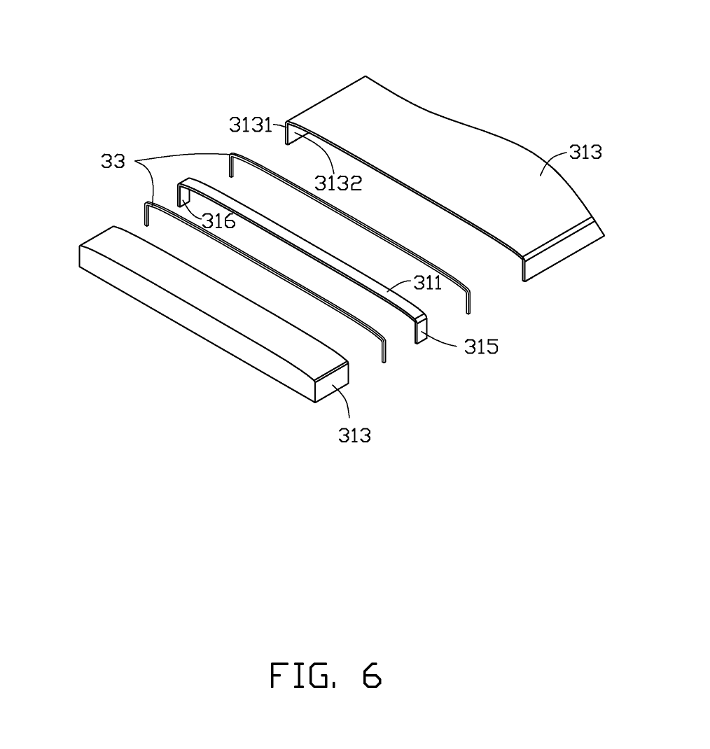

FIG. 6 illustrates that in at least one exemplary embodiment, the number of the non-conductive elements 33 can be two, and the non-conductive elements 33 can be connected with the lateral surfaces 315, 3131 and filled into the nano-pores 317 of the lateral surfaces 315, 3131.

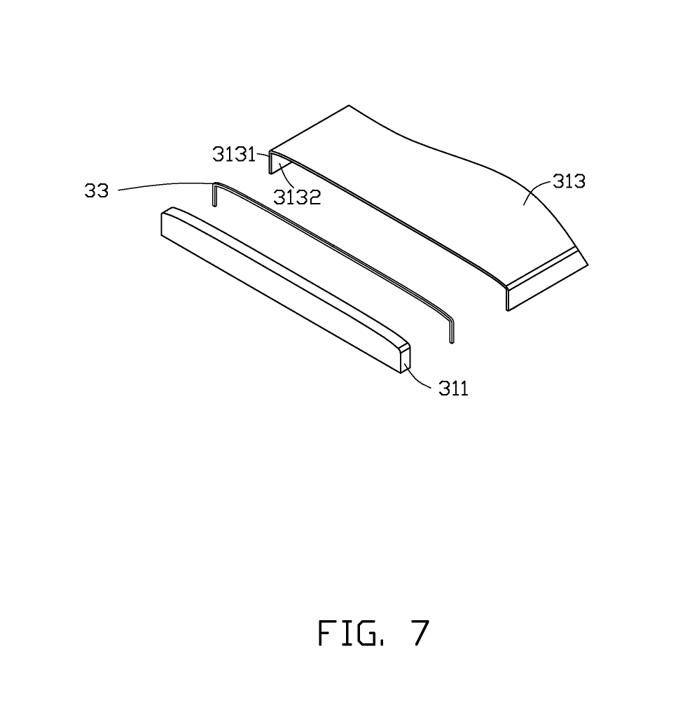

FIG. 7 illustrates that in at least one exemplary embodiment, one non-conductive element 33 can be connected with the lateral surfaces 315, 3131 and filled into the nano-pores 317 of the lateral surfaces 315, 3131. The non-conductive elements 33 can be substantially sheet-shaped.

Parts of the surfaces of the main body 313 and the metal sheet 311 can be coated with a shield film, thus the area coated with the shield film cannot be oxidized to form the nano-pores 317.

The non-conductive elements 33 can be respectively positioned between each two adjacent metal sheets 311; each main body 313 and a metal sheet 311 adjacent to the body 313 cooperatively form the housing 300. The non-conductive element 33 can be made of resin, ceramic, or glass. The resin can be selected from one or more of a group consisting of polyphenylene sulfide (PPS), polybutylene terephthalate (PBT), nylon (PA), polyethylene terephthalate (PET), polytrimethylene terephthalate (PTT), polyetherimide (PEI), polyether ether ketone (PEEK), poly(ethylene-co-1,4-cyclohexylenedimethylene terephthalate) (PCT), and their modified materials, such as a polyurethane ultraviolet curing resin composition. For example, fiberglass may be added to PPS. The fiberglass may have a mass percentage of about 20-40%. The thickness of the portion of non-conductive elements 33 covering the internal surfaces 316, 3132 is about 0.6 mm to about 1.0 mm perpendicular to a direction from an adjacent non-conductive element 33 located at one side of metal sheet 311 to another adjacent non-conductive element 33 located at an opposite side of the metal sheet 311. The thickness of the portion of the non-conductive elements 33 covering the lateral surfaces 315, 3131 is about 0.1 mm to about 0.3 mm along a direction from an adjacent non-conductive element 33 located at one side of metal sheet 311 to another adjacent non-conductive element 33 located at an opposite side of the metal sheet 311.

The non-conductive elements 33 can be transparent or non-transparent. Pigments can also be added in the non-conductive elements 33, so that the non-conductive elements 33 can be colorful. The non-conductive elements 33 can also be patterned.

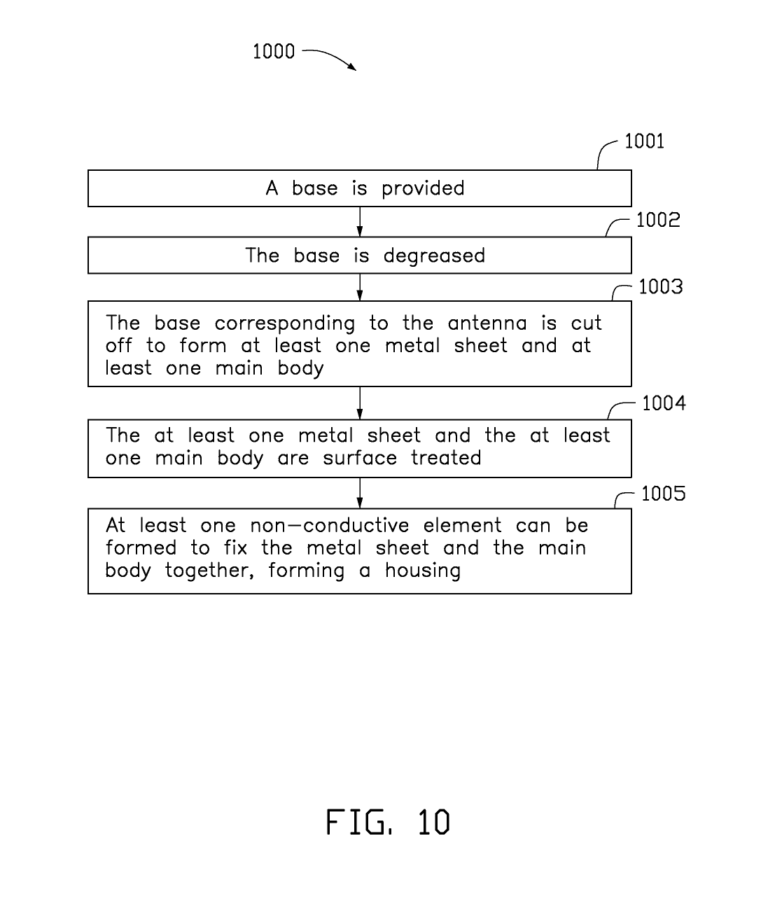

Referring to FIG. 10, a flowchart is presented in accordance with an example embodiment. The method 1000 is provided by way of example, as there are a variety of ways to carry out the method. The method 1000 described below can be carried out using the configurations illustrated in FIGS. 1-9, for example, and various elements of these figures are referenced in explaining example method 1000. Each block shown in FIG. 10 represents one or more processes, methods or subroutines, carried out in the example method 1000. Furthermore, the order of blocks is illustrative only and the order of the blocks can change according to the present disclosure. Additional blocks may be added or fewer blocks may be utilized, without departing from this disclosure. The example method 1000 for making the housing 30 can begin at block 1001.

At block 1001, a base 31 is provided. The base 31 having a desired three-dimensional shape of the housing 30 is provided. The base 31 can be made by casting, punching, or computer number control.

At block 1002, the base 31 is degreased. The degreasing process may include dipping the base 31 in a sodium salt water solution for about 5 minutes to about 15 minutes. The sodium salt solution may include sodium carbonate having a concentration of about 30-50 grams per liter (g/L), sodium phosphate having a concentration of about 30-50 g/L, and sodium silicate having a concentration of about 3-5 g/L. The temperature of the sodium salt solution may be about 50° C. to about 60° C. Once degreased, the base 31 is removed from the sodium salt solution and rinsed in water.

At block 1003, sections of a portion of the base 31 corresponding to the antenna 40 can be cut off, forming at least one gap 319. Remaining sections of the base 31 are spaced by the at least one gap 319 and form at least one metal sheet 311 and at least one main body 313. Each metal sheet 311 has two lateral surfaces 315 parallel to each other, and an internal surface 316 connected with the lateral surfaces 315. The main body 313 also has a lateral surface 3131 facing the lateral surfaces 315 of the metal sheets 311, and an internal surface 3132 adjacent to the lateral surface 3131. In at least one exemplary embodiment, the base 31 can be cut off by a computer numerical control process, or a laser cutting technology.

FIGS. 4-5 illustrate that in at least one exemplary embodiment, the base 31 can be spaced by the gaps 319 and form two metal sheets 311 and two main bodies 313, and a plurality of non-conductive elements 33 can be positioned in the gaps 319 to bond the metal sheets 311 and the main bodies 313 together. The number of the non-conductive elements 33 can be three.

FIG. 6 illustrates that in at least one exemplary embodiment, the base 31 can be spaced by the gaps 319 and form one metal sheet 311 and two main bodies 313, and two non-conductive elements 33 can be respectively positioned in the gaps 319 to bond the metal sheet 311 and the main bodies 313 together.

FIG. 7 illustrates that in at least one exemplary embodiment, the base 31 can be spaced by the gap 319 and form one metal sheet 311 and one main body 313, and one non-conductive element 33 can be positioned in the gap 319 to bond the metal sheet 311 and the main body 313 together.

At block 1004 a plurality of nano-pores 317 can be formed on the lateral surfaces 315, 3131 and/or the internal surfaces 316, 3132 by a surface treatment method. The surface roughness of the lateral surfaces 315, 3131 and/or the internal surfaces 316, 3132 can be about 0.1 μm to about 1 μm. The surface treatment method can be carried out by the following methods:

In a first method, the lateral surfaces 315, 3131 and/or the internal surface 316, 3132 can be electrochemically etched to form the nano-pores 317. The diameter of the nano-pores 317 can be about 20 nm to about 60 nm. The electrochemical etching process may be carried out in an acidic solution containing sulfuric acid and phosphoric acid, with the metal sheet 311 and the main body 313 being an anode, and a stainless steel board or a lead plate being a cathode. The sulfuric acid may have a concentration of about 30-50 ml/L, and the phosphoric acid may have a concentration of about 20-60 ml/L. The electric current density through the acid solution is about 2-4 ampere per square decimeter (A/dm²). Electrochemical etching the metal sheet 311 and the main body 313 may last for about 8 minutes to about 15 minutes, which is considerably less time and more effective than an anodizing process (about 20-60 minutes) for forming nano-pores. Next, the metal sheet 311 and the main body 313 can be rinsed in water and then dried. An energy dispersive spectrometer (EDS) test indicates that no alumina or other oxide film forms on the lateral surfaces 315, 3131 and/or the internal surfaces 316, 3132 after the metal sheet 311 and the main body 313 are electrochemically etched.

During the electrochemical etching process, metal on the surface of the metal sheet 311 and the main body 313 can lose electrons to form ions in the acidic solution, as such, the metal sheet 311 and the main body 313 can be etched and nano-pores 317 are formed. In the exemplary embodiment, the electrochemical etching process is substantially different from the anodizing process for aluminum alloy, which is substantially the process of forming alumina having nano-pores on the aluminum alloy. Furthermore, compared to conventional chemical etching process, the electrochemical etching process in the exemplary embodiment is effective in forming nano-pores in the metal sheet 311 and the main body 313, and the nano-pores 317 are of a more uniform shape, with a narrow range of diameters, and are evenly distributed in the metal sheet 311 and the main body 313.

In a second method, the metal sheet 311 and the main body 313 can be dipped in an aqueous solution at a temperature of about 40° C. to about 70° C. to form nano-pores 317 having a diameter of about 30 nm to about 300 nm on the lateral surfaces 315, 3131 and/or the internal surface 316, 3132. The dipping process may last for about 10-30 minutes. The aqueous solution can include a nitrogen-containing compound having a mass percentage of about 3-10%, and water having a mass percentage of about 90-97%. In the dipping process, the nano-pores 317 can adsorb the nitrogen-containing compound attributable to hydrazine to a surface of the nano-pores 317. An energy dispersive spectrometer (EDS) test indicates that no alumina or other oxide film forms on the lateral surfaces 315, 3131 and/or the internal surfaces 316, 3132 after the dipping process.

The nitrogen-containing compound can be one or more selected from a group consisting of ammonia, hydrazine, and a water-soluble amine compound. The water-soluble amine compound can be selected from a group consisting of aminomethane (CH₃NH₂), dimethylamine ((CH₃)₂NH), trimethylamine ((CH₃)₃N), ethylamine (C₂H₅NH₂), diethylamine ((C₂H₅)₂NH), triethylamine ((C₂H₅)₃N), ethylene diamine (H₂NCH₂CH₂NH₂), ethanolamine (HOCH₂CH₂NH₂), allylamine (CH₂CHCH₂NH₂), diethanolamine ((HOCH₂CH₂)₂NH), aniline (C₆H₇N) and triethanol amine ((HOCH₂CH₂)₃N).

In a third method, the lateral surfaces 315, 3131 and/or the internal surfaces 316, 3132 can be treated by an anodizing process to form an alumina film having a plurality of nano-pores 317. The nano-pores 317 can have a diameter of about 10 nm to about 200 nm.

The anodizing process may be carried out in an acid water solution containing sulfuric acid at about 10° C. to about 30° C., with the metal sheet 311 and the main body 313 being an anode, and a stainless steel board or a lead plate being a cathode. The sulfuric acid may have a mass percentage of about 10% to about 30%. The electric current density through the acid solution is about 2 amperes per square decimeter (A/dm²) to about 4 A/dm². Electrochemical etching the metal sheet 311 and the main body 313 may last for about 8 minutes to about 15 minutes, which is considerably less time and more effective than an anodizing process (about 20 minutes to about 60 minutes) for forming nano-pores 317. Next, the metal sheet 311 and the main body 313 can be rinsed in water and then dried.

In a fourth method, the lateral surfaces 315, 3131 and/or the internal surfaces 316, 3132 can be chemically etched to form a plurality of nano-pores 317 having a diameter of about 30 nm to about 55 nm on the lateral surfaces 315, 3131 and/or the internal surface 316, 3132. The chemical etching can be acid chemical etching or alkali chemical etching.

The acid chemical etching can be carried out by dipping the metal sheet 311 and the main body 313 in an acid solution for about 1 minute to about 10 minutes to remove any residue of oxidation, and form a plurality of nano-pores 317 on the lateral surfaces 315, 3131 and/or the internal surface 316, 3132. The nano-pores 317 can have a diameter of about 30 nm to about 55 nm. The acid solution may be a conventional acid solution. The acid solution in this embodiment may have a concentration of about 30 ml/L to about 80 ml/L. The temperature of the acid solution may be about 20° C. to about 30° C. Next, the metal sheet 311 and the main body 313 can be removed from the acid solution and rinsed with water. An energy dispersive spectrometer (EDS) test indicates that no alumina or other oxide film forms on the lateral surfaces 315, 3131 and/or the internal surfaces 316, 3132 after the acid chemical etching process.

Alkali chemical etching can be carried out by repeatedly dipping the metal sheet 311 and the main body 313 in an alkali solution to form a plurality of nano-pores 317 on the lateral surfaces 315, 3131 and/or the internal surfaces 316, 3132. The nano-pores 317 can have a diameter of about 20 nm to about 200 nm. The number of repetitions can be about 10 times to about 40 times, and each dipping may last for about 1 minute to about 3 minutes. After each dipping process, the metal sheet 311 and the main body 313 may be removed from the alkali chemical solution and rinsed with water.

An energy dispersive spectrometer (EDS) test indicates that no alumina or other oxide film forms on the lateral surfaces 315, 3131 and/or the internal surface 316, 3132 after the acid chemical etching process.

The alkali chemical solution can include a salt having a mass percentage of about 1-5%, and water having a mass percentage of about 95-99%. The salt can be one or more selected from a group consisting of sodium phosphate, sodium carbonate, acetate salt and sulfite salt. The sodium carbonate can be one or more selected from a group consisting of sodium carbonate, sodium bicarbonate, ammonium acid carbonate, and potassium carbonate. The sodium phosphate can be one or more selected from a group consisting of sodium phosphate tribasic. The acetate can be sodium acetate. The sulfite can be one or more selected from a group consisting of sodium sulfate, sodium bisulfate, potassium sulfite and ammonium sulfite. The sodium phosphate, sodium carbonate, acetate salt and sulfite salt can distribute the nano-pores 317 uniformly on the lateral surfaces 315, 3131 and/or the internal surfaces 316, 3132, and can also make the nano-pores 317 have uniform diameters, such that the non-conductive element 33 can strongly bond with the metal sheets 311 and the main bodies 313.

In at least one exemplary embodiment, sections of a portion of the metal sheets 311 and the main bodies 313 can be coated with a shield layer to protect the portion of the metal sheets 311 and the main bodies 313 from being surface treated. In at least another exemplary embodiment, the metal sheets 311 and the main bodies 313 may not be coated with a shield layer, and all the surface of the metal sheets 311 and the main bodies 313 have nano-pores 317.

At block 1005, the non-conductive element 33 can be formed by either of the following two methods:

In a first method, the non-conductive element 33 can be formed by an injection process. The injection process includes providing an injection mold which includes a core insert and a cavity insert. The core insert can have several gates, and several first cavities. The cavity insert can have a second cavity for receiving the metal sheet 311 and the main body 313. The at least one metal sheet 311 and the at least one main body 313 can be located in the second cavity, each two adjacent metal sheets 311, and the at least one main body 313 and the metal sheet 311 adjacent to the main body 313 can be spaced by at least one gap 319. Each gap 319 can have a width of about 0.1 mm to about 0.3 mm along a direction from an adjacent non-conductive element 33 located at one side of metal sheet 311 to another adjacent non-conductive element 33 located at an opposite side of the metal sheet 311. Molten resin is injected through the gates to fill the at least one gap 319 and cover the lateral surfaces 315, 3131 and/or the internal surfaces 316, 3132, forming the at least one non-conductive element 33, as such the housing 30 is formed. During the molding process, the injection mold may be at a temperature of about 120° C. to about 140° C. The thickness of the portion of the non-conductive element covering the internal surfaces 316, 3132 is about 0.6 mm to about 1.0 mm perpendicular to a direction from an adjacent non-conductive element 33 located at one side of metal sheet 311 to another adjacent non-conductive element 33 located at an opposite side of the metal sheet 311. The thickness of the portion of the non-conductive element 33 covering the lateral surfaces 315, 3131 is about 0.1 mm to about 0.3 mm along a direction from an adjacent non-conductive element 33 located at one side of metal sheet 311 to another adjacent non-conductive element 33 located at an opposite side of the metal sheet 311.

The molten resin may be any resin having high fluidity. The resin can be selected one or more from a group consisting of polyphenylene sulfide (PPS), polybutylene terephthalate (PBT), nylon (PA), polyethylene terephthalate (PET), polytrimethylene terephthalate (PTT), polyetherimide (PEI), polyether ether ketone (PEEK), poly(ethylene-co-1,4-cyclohexylenedimethylene terephthalate) (PCT), and their modified materials, such as a polyurethane ultraviolet curing resin composition. For example, fiberglass may be added to PPS. The fiberglass may have a mass percentage of about 20-40%.

In the second method, at least one non-conductive element 33 can be formed by an injection process. Each non-conductive element 33 may have a thickness of about 0.1 mm to about 0.3 mm along a direction from a non-conductive element 33 located at one side of the metal sheet 311 to another adjacent non-conductive element 33 located at an opposite side of the metal sheet 311. Then, the at least one metal sheet 311, the at least one main body 313 and the at least one non-conductive element 33 can be located in a mold, the non-conductive element 33 can be positioned between each two adjacent metal sheets 311, between the main body 313 and the metal sheet 311 adjacent to the main body 313. The at least one metal sheet 311, the at least one main body 313 and the at least one non-conductive element 33 can be heated at about 250° C. to about 300° C. The two opposite ends of the base 31 can be pressed along a direction from one main body 31 toward the metal sheet 311 for about 0.5-3 minutes, such that the non-conductive element 33 can fill the nano-pores 317, and fix the at least one metal sheet 311 and the at least one main body 313 together. The pressure can be about 2 MPa to about 100 MPa. The thickness of the portion of the non-conductive element 33 covering the internal surfaces 316, 3132 is about 0.6 mm to about 1.0 mm perpendicular to a direction from an adjacent non-conductive element 33 located at one side of metal sheet 311 to another adjacent non-conductive element 33 located at an opposite side of the metal sheet 311. The thickness of the portion of the non-conductive element 33 covering the lateral surfaces 315, 3131 is about 0.1 mm to about 0.3 mm along a direction from an adjacent non-conductive element 33 located at one side of metal sheet 311 to another adjacent non-conductive element 33 located at an opposite side of the metal sheet 311.

In at least one exemplary embodiment, the non-conductive element 33 can be sheet-shaped. The non-conductive element 33 can fill the nano-pores 317 of the oxide film, and bond with the oxide film formed on the lateral surfaces 315, 3131.

In at least one exemplary embodiment, the non-conductive element 33 can be substantially “T” shaped. The non-conductive element 33 can fill the nano-pores of the oxide film, and bond with the oxide film formed on the lateral surfaces 315, 3131 and the internal surfaces 316, 3132.

In at least one exemplary embodiment, the non-conductive element 33 can be sheet-shaped. The non-conductive element 33 can fill the nano-pores directly formed on the lateral surfaces 315, 3131.

In at least one exemplary embodiment, the non-conductive element 33 can be substantially “T” shaped. The non-conductive element 33 can fill the nano-pores directly formed on the lateral surfaces 315, 3131 and the internal surface 316, 3132.

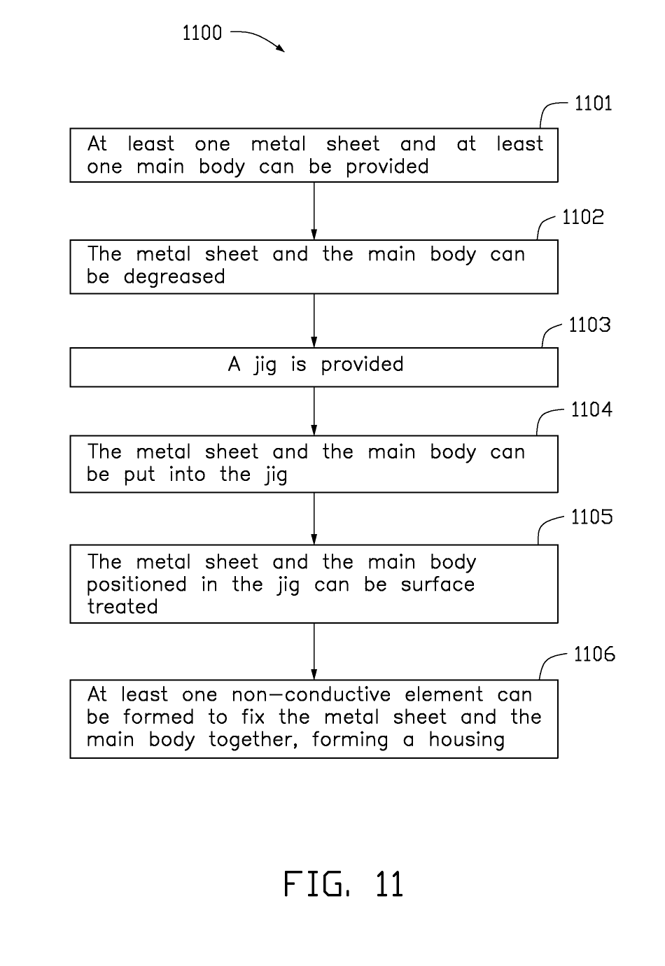

Referring to FIG. 11, another flowchart is presented in accordance with an example embodiment. The method 1100 is provided by way of example, as there are a variety of ways to carry out the method. The method 1100 described below can be carried out using the configurations illustrated in FIGS. 1-9, for example, and various elements of these figures are referenced in explaining example method 1100. Each block shown in FIG. 11 represents one or more processes, methods or subroutines, carried out in the example method 1100. Furthermore, the illustrated order of blocks is illustrative only and the order of the blocks can change according to the present disclosure. Additional blocks may be added or fewer blocks may be utilized, without departing from this disclosure. The example method 1100 for making the housing 30 can begin at block 1101.

At block 1101, at least one metal sheet 311 and at least one main body 313 is provided.

At block 1102, the metal sheet 311 and the main body 313 isdegreased. The degreasing process may include dipping the metal sheet 311 and the main body 313 in a sodium salt water solution for about 5 minutes to about 15 minutes. The sodium salt solution may include sodium carbonate having a concentration of about 30-50 grams per liter (g/L), sodium phosphate having a concentration of about 30-50 g/L, and sodium silicate having a concentration of about 3-5 g/L. The temperature of the sodium salt solution may be about 50-60° C. Once degreased, the metal sheet 311 and the main body 313 can be removed from the sodium salt solution and rinsed in water.

At block 1103, a jig (not shown) is provided; the jig has a plurality of hooks (not shown).

At block 1104, the metal sheet 311 and the main body 313 are put into the jig. The width of the gaps 317 between the two adjacent metal sheets 311 and gaps 317 between the main body 313 and the metal sheet 311 adjacent to the main body 313 can be adjusted to about 0.1 mm to about 0.3 mm along a direction from an adjacent non-conductive element 33 located at one side of metal sheet 311 to another adjacent non-conductive element 33 located at an opposite side of the metal sheet 311. Then the metal sheet 311 and the main body 313 can be fixed by the hooks.

FIGS. 4-5 illustrate that in at least one exemplary embodiment, the number of the main body 313 and the metal sheet 311 can both be two.

FIG. 6 illustrates that in at least one exemplary embodiment, the number of the main body 313 can be two, and the number of the metal sheet 311 can be one.

FIG. 7 illustrates that in at least one exemplary embodiment, the number of the main body 313 and the metal sheet 311 can both be one.

At block 1105, the metal sheet 311 and the main body 313 positioned in the jig can be surface treated to form a plurality of nano-pores 317 on the lateral surfaces 315, 3131 and the internal surfaces 316, 3132. The surface treatment method can be the same as the above surface treatment methods as described in block 1004.

At block 1106, each non-conductive element 33 can be positioned in one corresponding gap 319 to fix the at least one metal sheet 311 and the at least one main body 313 together, forming the housing 30. The thickness of the portion of the non-conductive element 33 covering the internal surfaces 316, 3132 is about 0.6 mm to about 1.0 mm perpendicular to a direction from an adjacent non-conductive element 33 located at one side of metal sheet 311 to another adjacent non-conductive element 33 located at an opposite side of the metal sheet 311. The thickness of the portion of the non-conductive element 33 covering the lateral surfaces 315, 3131 is about 0.1 mm to about 0.3 mm along a direction from an adjacent non-conductive element 33 located at one side of metal sheet 311 to another adjacent non-conductive element 33 located at an opposite side of the metal sheet 311. The methods of making the non-conductive element 33 can be the same as the above methods of making the non-conductive element 33 as described in block 1005.

Tensile strength and shear strength of the housing 30 have been tested, indicating that the tensile strength of the housing 30 is greater than 10 MPa, and the shear strength of the housing 30 is greater than 20 MPa. Furthermore, the housing 30 has been subjected to a temperature humidity bias testing (72 hours, 85° C., relative humidity: 85%) and a thermal shock test (48 hours, −40-85° C., 4 hours/cycle, 12 cycles total), such testing did not result in decreased tensile strength and shear strength of the housing 30.

It is to be understood, however, that even through numerous characteristics and advantages of the present disclosure have been set forth in the foregoing description, together with details of assembly and function, the disclosure is illustrative only, and changes may be made in detail, including in the matters of shape, size, and arrangement of parts within the principles of the disclosure to the full extent indicated by the broad general meaning of the terms in which the appended claims are expressed.

What is claimed is:

1. A method of making a housing comprising:
providing at least one metal sheet and at least one main body, the metal sheet having two lateral surfaces parallel to each other, the main body defining a lateral surface opposite to the metal sheet;
locating the at least one metal sheet and the at least one main body into a mold, the at least one main body and the at least one metal sheet being spaced by at least one gap;
adjusting a width of the gap between the at least one main body and the metal sheet adjacent to the main body; and
forming at least one non-conductive element by filling liquid resin into the gap,
wherein the non-conductive element, the metal sheet, and the main body cooperatively form the housing.

2. The method as claimed in claim 1, wherein the width of the gap between the at least one main body and the metal sheet adjacent to the main body is about 0.1 mm to about 0.3 mm along a direction from an adjacent non-conductive element located at one side of metal sheet to another adjacent non-conductive element located at an opposite side of the metal sheet.

3. The method as claimed in claim 1, wherein each two adjacent metal sheets are spaced by one gap, the gap between the each two adjacent metal sheets has a width of about 0.1 mm to about 0.3 mm along a direction from an adjacent non-conductive element located at one side of metal sheet to another adjacent non-conductive element located at an opposite side of the metal sheet.

4. The method as claimed in claim 1, wherein the at least one metal sheet and the at least one main body are surface treated to form a plurality of nano-pores having a diameter of about 10 nm to about 300 nm on the lateral surfaces of the metal sheet and the lateral surface of the main body, and the at least one non-conductive element is filled into the nano-pores and covers the lateral surfaces of the metal sheet and the lateral surface of the main body.

5. The method as claimed in claim 4, wherein sections of a portion of the non-conductive element covering the lateral surfaces of the metal sheet and the lateral surface of the main body have a thickness of about 0.1 mm to about 0.3 mm along a direction from an adjacent non-conductive element located at one side of metal sheet to another adjacent non-conductive element located at an opposite side of the metal sheet.

6. The method as claimed in claim 1, wherein each metal sheet further has an internal surface adjacent to the lateral surface of the metal sheet, the main body further also has an internal surface adjacent to the lateral surface of the base, the internal surface of the metal sheet and the internal surface of the base are surface treated to form a plurality of nano-pores having a diameter of about 10 nm to about 300 nm, the non-conductive element is filled into the nano-pores and covers the internal surface of the metal sheet and the internal surface of the main body.

7. The method as claimed in claim 6, wherein sections of a portion of the non-conductive element covering the internal surface of the metal sheet and the internal surface of the main body have a thickness of about 0.6 mm to about 1.0 mm perpendicular to a direction from an adjacent non-conductive element located at one side of metal sheet to another adjacent non-conductive element located at an opposite side of the metal sheet.

8. The method as claimed in claim 1, wherein the at least one metal sheet and at least one main body are formed by cutting the base.

9. The method as claimed in claim 6, wherein the metal sheet and the main body are located in a jig, and the metal sheet and the main body located in the jig are surface treated to form a plurality of nano-pores on the metal sheet and the main body.

10. A housing, comprising:
a base having:
at least one metal sheet having a plurality of nanopores; and
at least one main body having a plurality of nanopores; and
at least one non-conductive element located at spaces between the at least one main body and the metal sheet adjacent to the main body, and filled into the nano-pores to bond the at least one metal sheet and the at least one main body together.

11. The housing as claimed in claim 10, wherein the at least one non-conductive element is further positioned between each two adjacent metal sheets to fix the each two adjacent metal sheets together, portions of the non-conductive elements located between the each two adjacent metal sheets, and between the at least one main body and the metal sheet adjacent to the main body have a width of about 0.1 mm to about 0.3 mm along a direction from an adjacent non-conductive element located at one side of metal sheet to another adjacent non-conductive element located at an opposite side of the metal sheet.

12. The housing as claimed in claim 11, wherein at least one gap exists between the two adjacent metal sheets, and between the main body and the metal sheet adjacent the main body, the gap has a width of about 0.1 mm to about 0.3 mm along a direction from an adjacent non-conductive element located at one side of metal sheet to another adjacent non-conductive element located at an opposite side of the metal sheet, the at least one non-conductive element is received in the at least one gap.

13. The housing as claimed in claim 10, wherein the at least one metal sheet has two lateral surfaces parallel to each other, the at least one main body has a lateral surface opposite to the metal sheet, a plurality of nano-pores having a diameter of about 10 nm to about 300 nm are formed on the lateral surfaces of the metal sheet and the lateral surface of the main body, the surface roughness of the lateral surfaces of the metal sheet and the main body is about 0.1 μm to about 1 μm.

14. The housing as claimed in claim 13, wherein the lateral surfaces of the metal sheet and the main body further respectively include an oxide film, the oxide films have a plurality of nano-pores having a diameter of about 10 nm to about 300 nm, the surface roughness of the lateral surfaces of the metal sheet and the main body having the oxide film is about 0.1 μm to about 1 μm.

15. The housing as claimed in claim 10, wherein the at least one metal sheet further has an internal surface adjacent to the lateral surface of the metal sheet, the at least one main body further has an internal surface adjacent to the lateral surface of the main body, the internal surface of the main body and the metal sheet both have a plurality of nano-pores having a diameter of about 10 nm to about 300 nm, sections of a portion of each non-conductive element are filled into the nano-pores of the internal surface and covers the main body and the metal sheet.

16. The housing as claimed in claim 15, wherein sections of the portion of each non-conductive element covering the internal surface of the main body and the metal sheet have a width of about 0.6 mm to about 1.0 mm perpendicular to a direction from an adjacent non-conductive element located at one side of metal sheet to another adjacent non-conductive element located at an opposite side of the metal sheet.

17. An electronic device, comprising:
a body;
a housing mounted on the main body, the housing comprising a base and at least one non-conductive element, the base having at least one metal sheet and at least one main body, the metal sheet and the at least one main body both having a plurality of nano-pores, the non-conductive element being located at the spaces between the at least one main body and the metal sheet adjacent to the main body, and filled into the nano-pores to bond the at least one metal sheet and the at least one main body together; and
an antenna assembled in the housing.

18. The electronic device as claimed in claim 17, wherein the at least one metal sheet has two lateral surfaces parallel to each other, the at least one main body has a lateral surface opposite to the metal sheet, the nano-pores having a diameter of about 10 nm to about 300 nm are directly formed on the lateral surfaces of the metal sheet and the lateral surface of the main body, sections of a portion of each non-conductive element are respectively filled into the nano-pores of the lateral surfaces, and cover the lateral surfaces of the metal sheet and the main body.

19. The electronic device as claimed in claim 18, wherein the at least one non-conductive element corresponds to the antenna.
